(19) United States
(12) Patent Application Publication
(10) Pub. No.: US 2005/0117741 A1
(43) Pub. Date: Jun. 2, 2005

(54) Telephone plug and jack with transmission various signals

(76) Inventor: Zhang-Mu Xu, New York, NY (US)

Correspondence Address: ZHANG-MU XU, 13-15 Clinton ST., Apt. 3B, New York, NY, 10002, US

(21) Appl. No.: 10/724,593

(22) Filed: Dec. 1, 2003

(51) Int. Cl. H04M 1/00; H04M 9/00

(52) U.S. Cl. 379/438

(57) ABSTRACT

The telephone plug and jack with transmission various signals, which involves the telephone plug, the telephone jack, and the connecting cable. The telephone jack/(or plug) is installing on the wall of the room or of the office; and the cable, which is connected with jack/(or plug), is connecting with the local telephone networking, this device is using as the client input terminal (access point) of the local telephone networking. It will be input and transmission with various signals at same time, such as audio signal, television signal, video signal, multimedia signal, the various analogue signals and digital signals. This device is a electric product. The telephone plug and jack are made up of plastic, and it's connecting cable is consisted of the twisted-pair cable, the shielded coaxial cable and the fibre-optic cable.

Figure is the new improved telephone plug, the telephone jack and the connecting cable. In this figure includes: the plug is viewing from top to down (7), the jack is viewing from front (8), the plug is viewing from left to right (9), the plug is viewing from bottom to up (10), and the connecting cable consists of the twisted-pair cable and the pair shielded coaxial cable (11).

### THE ART FIELD

This invention is a electric product, which involves the telephone plug, the telephone jack, and the correspondence connecting cable. This invention is belong to telecommunication field.

### BACKGROUND OF THE INVENTION

Since the 1876 telephone invents, the connection wire with all telephone device and the telephone networking have been invented at same time. During the hundred years, the function of communication networking is using chiefly for the telephone business. Although, due to the development of the telephone technology, the function of the telephone machine and the telephone networking have been improved and advanced, but the telephone plug and jack with connecting twisted-pair-cable, which is using up to now, is still using the old product, which was designed about fifty years ago.

During the recent fifty years, due to the invention of the television and the personal computer, the various plugs (and jacks) with new function and new shape has been invented, for example, the plug with the shielded coaxial cable is used for television and the plugs with correspondence connection cable is used for computer, but these only have been used for a shout-distance and for the different use.

The similar plug (or jack) with correspondence connection cable have never be used by telephone industry as input-terminal device (client access point) of local telephone networking, never be used as the telephone plug and jack in the local telephone networking.

### THE INTENTION OF INVENTION

Because of the telephone networking, which is best complete and most perfect, have two strong point and advantages as follows:

1) Complete: The telephone networking is covered the all region of whole world. It means, under the connection of telephone networking, it can be transmit signal goes to the super-long distance, until to all towns, to all nations in the worldwide.

2) Universality: Because of the telephone networking is widely available and extended to the each family, each room and each office in all countries. Therefore, the telephone signal can also transmit to all houses, all offices, to anywhere, anyplace in the whole world it is the most perfect local network.

Because the public telephone exchanges network, which had been management and develop more than 100 years, has become already on a vast scope, it's complete and universality of telecommunication transmission are that the other any telecommunication industry and information industry cannot compare to it. But, since the telephone invents, the design of it's usage is stayed around to use for audio signal. Therefore, the telephone plug, jack with it's connecting cable are still designed for transmission of audio signal only, this is the telephone plug and jack with the twisted-pair cable at current use.

At last twenty years, because of the computer and the internet technology have been development, the customer increases needs to transmit for the video signal and the super-speed data communication, but the telephone industry cannot provide such technique and business.

With the business of wireless phone, cable television and internet network are development very quickly in the last years, although there have got the advantage high-technology support, but it's covered region and universal rate are cannot catch up with the local telephone network, therefore, along with future technical development of telecommunication, it is very necessary that to exert it's two strong point of telephone network said above connects with the modernization new transmission technology of telecommunication, to improve various functions of input and synchronous transmission for various video signal and digital signal with super-long distance and superhighspeed. The telephone function, which is based on the transmission of audio signal only, increase to input and transmit for television signal, video signal and digital signal; which is based on the transmission of telecommunication signal systems, increase to input and transmit for information signal systems, finally, the local telephone network, which not only can transmits audio signal, but also transmits the television signal, video signal, and other various signals with digital and images (multimedia). The intention of this invention is design a new improved telephone plug and new jack with new connecting cable for using to future local telephone networking, make telephone network can entered to synchronous transmission the various big capacity signal with superhighspeed. And it also will be applied to development for the information superhighway.

### SUMMARY OF THE INVENTION

For the sake of meet the future technical development in telephone networking with transmission for various analogue signals and digital signals, the telephone plug (and jack) with twisted-pair cable is cannot meet our demand. We have to need to usage the other kinds of connecting cable and change shape of plug and jack, or to add more wire numbers with various cables. So the telephone plug and jack of the original rectangle shape have need to change to the any other shape, or circle, or shape, or other various difference shapes; the connecting cable, which is connected with the plugs or the jacks, will be consisted of the twisted-pair cable, shielded coaxial cable, fibre-optic cable and any high-capacity cable.

For example, the original telephone plug/(and jack), which is using up to now, is a rectangle, the connecting line's number of interface is two lines or four lines only, it's connecting cable is twisted-pair cable.

The new improved telephone plug/(and jack) with connecting cable will be:

The shape of the plug/(or jack) is new shaped it can be a circle shaped, or [symbol] shaped, or [symbol] shaped, [symbol] shaped, or other any shaped.

The line's number of interconnecting with new telephone plug/(or jack) are 8 lines, 12 lines, and until to N lines (N=1, 2, 3, 4, 5, - - - 99 - - - n - - - ).

It's connecting cable will be consisted of the twisted-pair cable, the shielded coaxial cable, the fibre-optic cable, and the any high-capacity cable. It can be a kind of any cable, (such as the shielded coaxial cable only, or the fibre-optic cable only); Or it also can be a mixed cable, which is consisted of any two kinds (such as mixed of twisted-pair cable with the shielded coaxial cable) Or any three kinds (such as mixed of twisted-pair cable with the shielded coaxial cable and the fibre-optic cable), or any four kinds, - - - .

The beneficial result of this invention is: In time wired the new connecting cable and installed the new telephone plugs and jacks as the client input-terminal in the local telephone networking, because of it is broadband input, it's function with communication ability will be increase greatly, which is input and transmit not only the audio signal, it will be input and transmit the television signal, video signal, and the signals with digital and images (multimedia) also; which is input and transmit not only the telecomunication signals and analogue signal, it will be input and transmit the information signals and the signals with digital and images (multimedia) also, The various signals and information will be transmitted with superhighspeed and synchronous (such as Broadband input or B-ISDN). At this time, we will call this telephone network “The multi-functional telecommunications network or the information superhighway”.

### BRIEF DESCRIPTION ON THE DRAWINGS

FIG. 1 is the various different connecting cable or wires. In this figure includes: the insulated copper wire (1), the twisted cable (two insulated coppers wire twisted) (2), the twisted-pair cable (3) the shielded coaxial cable (4), the pair-shielded coaxial cable (5) and the fibre-optic cable (6).

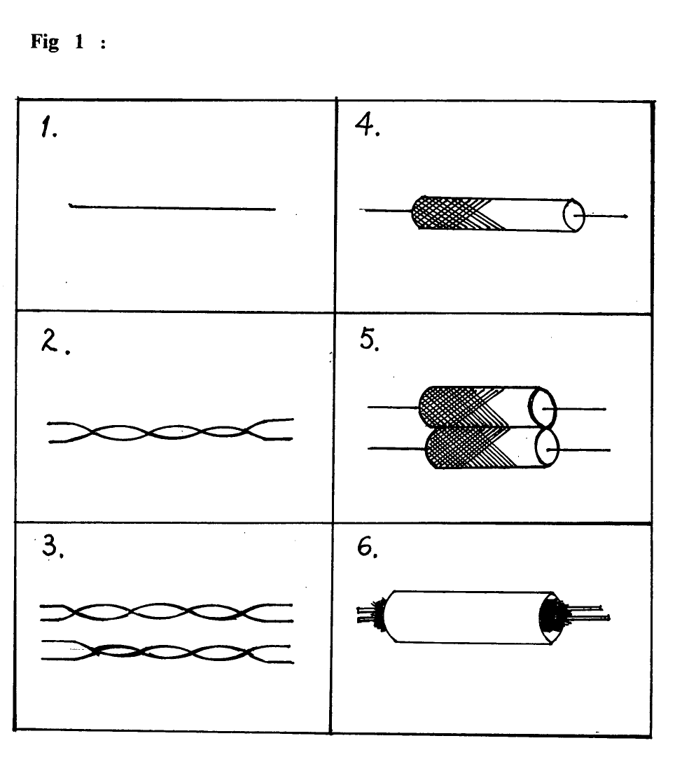

FIG. 2 is the original telephone plug, jack and the connecting cable (4 lines) of local telephone networking, which is using up to now, it's connecting cable consists of the twisted-pair cable. In this figure includes: the plug is viewing from top to down (7), the jack is viewing from front (8), the plug is viewing from left to right (9) the plug is viewing from bottom to up (10), and the 4-line connecting cable consists of the twisted-pair cable (11).

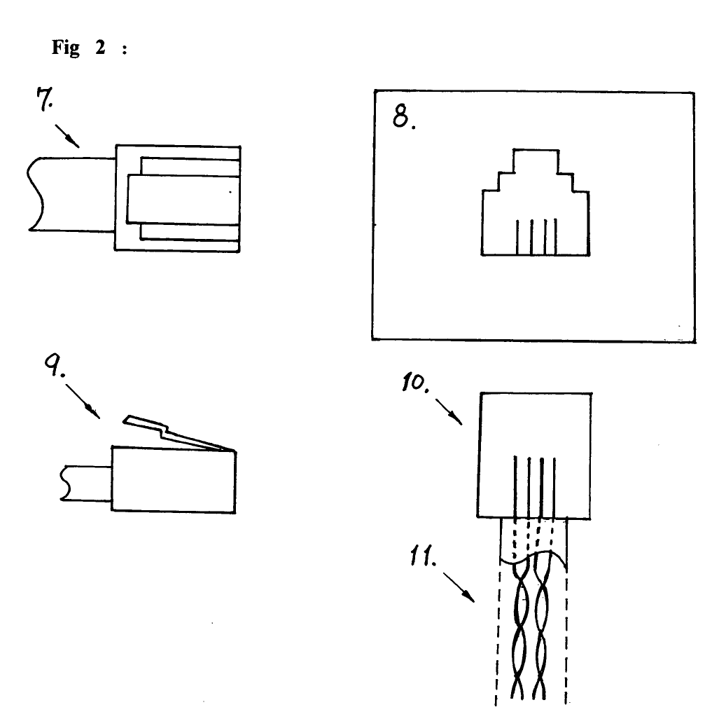

FIG. 3 is the new improved telephone plug, jack and the connecting cable (8 lines) of local telephone networking, which will be use for telephone and television, it's connecting cable consists of the twisted-pair cable and the pair shielded coaxial cable. In this figure includes: the plug is viewing from top to down (7), the jack is viewing from front (8), the plug is viewing from left to right (9), the plug is viewing from bottom to up (10), and the 8-line connecting cable consists of the twisted-pair cable and the pair shielded coaxial cable (11).

FIG. 4 is the new improved telephone plug, jack and the connecting cable (8 lines) of local telephone networking, which will be use for telephone and television, but the shape of plug/(and jack) will be changed to the circle shaped, it's connecting cable consists of the twisted-pair cable and the pair shielded coaxial cable. In this figure includes: the plug is viewing by elevation (12), the jack is viewing by elevation (13), make the A-A section of plug (12), which is viewing by section (14), make the B-B section of jack (13), which is viewing by section (15), and the 8-line connecting cable consists of the twisted-pair cable and the pair shielded coaxial cable (16), the upper 4 points are connecting with the twisted-pair cable, and the lower a pair of circle are connecting with the pair-shielded coaxial cable.

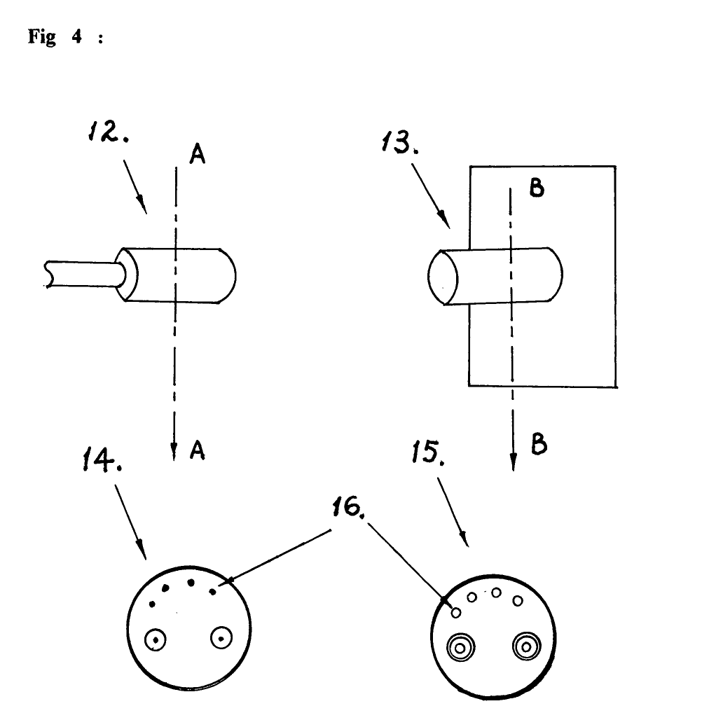

FIG. 5 is the new improved telephone plug, jack and the connecting cable (12 lines) of local telephone networking, which will be use for telephone, television and computer, it's connecting cable consists of the twisted-pair cable, the pair shielded coaxial cable and the twisted-pair cable. In this figure includes: the plug is viewing from top to down (7), the jack is viewing from front (8), the plug is viewing from left to right (9), the plug is viewing from bottom to up (10), and the 12-line connecting cable consists of the twisted-pair cable, the pair shielded coaxial cable and the another twisted-pair cable (11).

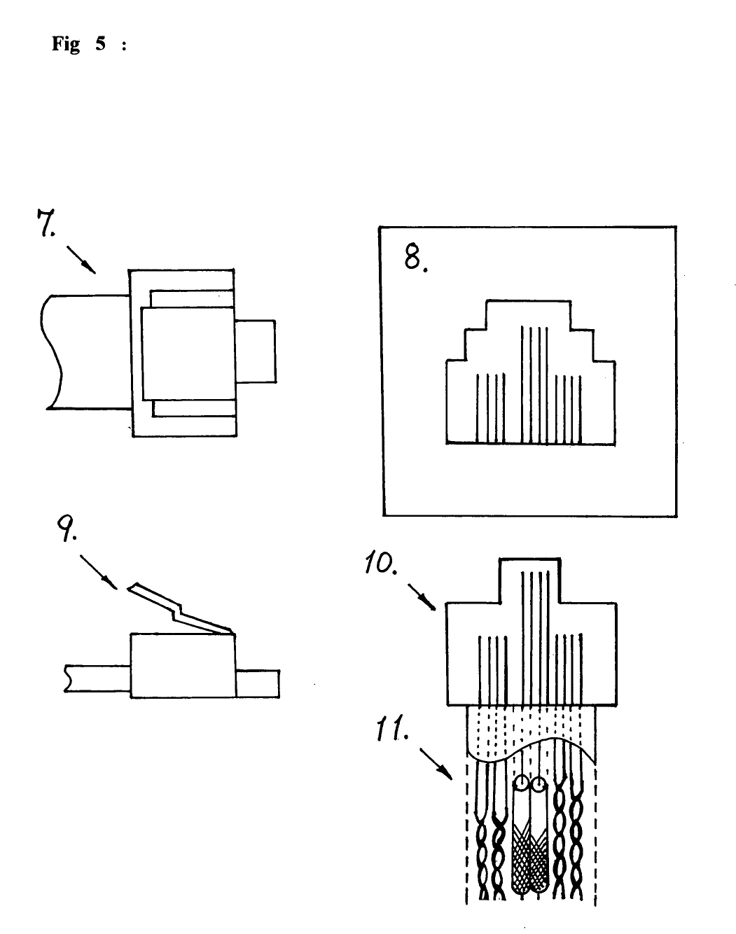

FIG. 6 is the new improved telephone plug, jack and the connecting cable (12 lines) of local telephone networking, which will be use for telephone, television and computer, it's connecting cable consists of the twisted-pair cable, the pair shielded coaxial cable and the fibre-optic cable. In this figure includes: the plug is viewing by elevation (12), the jack is viewing from front (13), make the A-A section of plug (12), which is viewing by section (14), and the 12-line connecting cable consists of the twisted-pair cable, the pair shielded coaxial cable and the fibre-optic cable (16).

FIG. 7 is that: if cut the new improved telephone plug, jack and the connecting mixed cable (See FIG. 6) into the three separate parts, the part of left is connecting with the twisted-pair cable, like drawing in FIG. 2, and the other two separate part is connecting with the pair shielded coaxial cable (or the fibre-optic cable), like drawing in this FIG. 7. So, the FIG. 7 is the new improved telephone plug, jack and the connecting cable (4 lines) of local telephone networking, which will be use for telephone, television, computer, it's connecting cable is the pair shielded coaxial cable only (or the fibre-optic cable only). In this figure includes: the plug is viewing by elevation (12), the jack is viewing from front (13), make the A-A section of plug (12), which is viewing by section (14), and the 4-line connecting cable is the pair shielded coaxial cable (16) only (or the fibre-optic cable only).

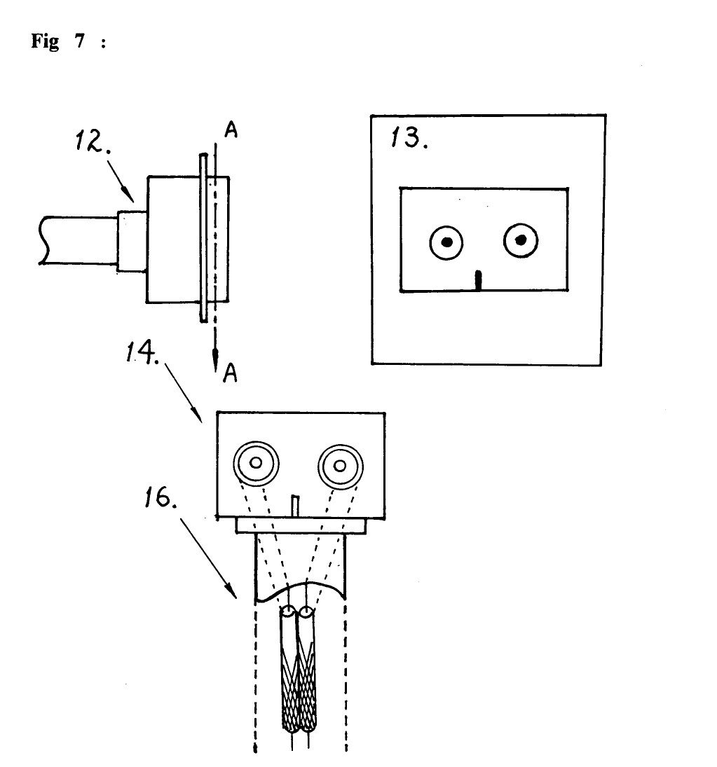

FIG. 8 is the new improved telephone plugs with the new correspondence connecting cable, which will be use as the interconnecting cable with the device and the local telephone network. It's construction is (plug-connecting cable-plug).

### DETAILED DESCRIPTION OF THE INVENTION

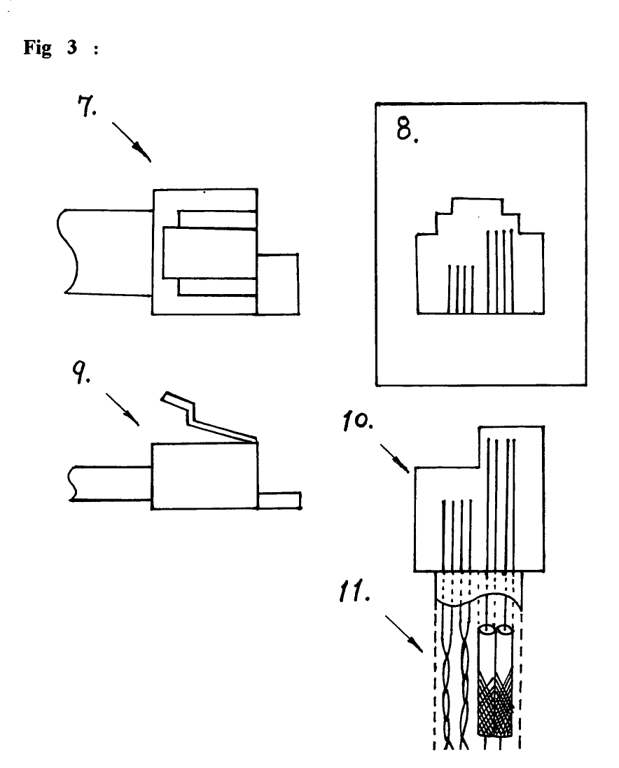

For example 1: Turning generally to FIG. 3: This invention “The telephone plug and jack with transmission various signals”, which involves the telephone plug (7) (9) (10), telephone jack (8), and it's connecting cable (11), it will be use for telephone and television, The connecting cable (11) consists of the twisted-pair cable (4 lines) and the pair shielded coaxial cable (4 lines, it's construction is the (jack-connecting cable)/or (plug-connecting cable).

First, the body of telephone plug and jack are made up of hard plastic, it is [symbol] shaped [see views (7) (9) (10)], and the correspondence jack is the view (8) the plug and jack are a complete set of equipment, which is to be used for insert and connection. The view (10) is the plan of plug, there have 8 copper lines on the bottom of the plug, which are using as connecting point of interface, and connected with connecting cable (11). The short lines are interconnecting with the twisted-pair cable by weld, when insert the plug in jack, the copper lines of plug are connects with the copper lines of jack, it's function is using to input and transmit the audio signal, which is like as the telephone signal current using. The long lines are interconnecting with a pair shielded coaxial cable by weld, when insert the plug in jack, the copper lines of plug are connects with the copper lines of jack, it's function is using to input and transmit the video signal, which is like as the cable-television signal current using. The correspondence connecting cable (11) consists of the twisted-pair cable and a pair shielded coaxial cable, The outside have two broken lines, which is covering with insulated plastic.

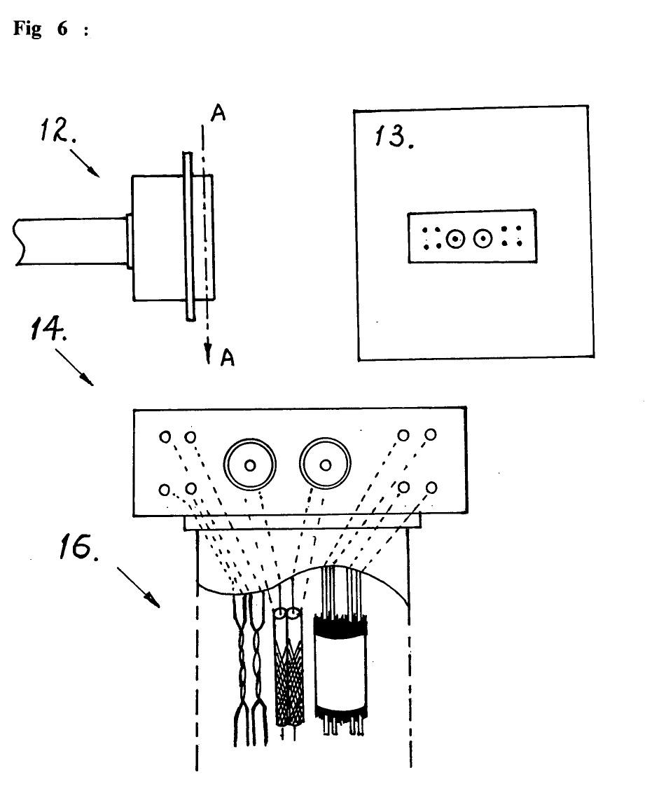

For example 2: Turning generally to FIG. 6: This invention “The telephone plug and jack with transmission various signals”, which involves the telephone plug (12) (14), the telephone jack (13) and it's connecting cable (16), it will be use for telephone, television and computer. The connecting cable (16) consists of the twisted-pair cable (4 lines), a pair shielded coaxial cable (4 lines) and the 4 fibre-optic cable (4 lines), it's construction is the (jack-connecting cable)/or (plug-connecting cable).

The body of telephone plug and jack are made up of hard plastic it is [symbol] shaped [see views (12) (14)], and the correspondence jack is the view (13), the plug and jack are a complete set of equipment, which is to be used for insert and connection. The view (14) is the section of plug by large, there have 12 copper lines on the bottom of the plug, which are using as connecting point of interface and connected with connecting cable (16). The left 4 lines are interconnecting with the twisted-pair cable by weld, when insert the plug in jack, the copper lines of plug are connects with the copper lines of jack, it's function is using to input and transmit the audio signal, which is like as the telephone signal current using. The middle two circle are interconnecting with a pair shielded coaxial cable by weld, when insert the plug in jack, the copper lines of plug are connects with the copper lines of jack, it's function is using to input and transmit the video signal, which is like as the cable-television signal current using. The right 4 lines are interconnecting with 4 fibre-optic cable (or other any high-capacity cable), when insert the plug in jack, the copper lines of plug are connects with the copper lines of jack, it's function is using to input and transmit the computer signal with digital and images (multimedia), it is also to input and transmit the various signals of information with great quantity and superhighspeed. The correspondence connecting cable (16) consists of the twisted-pair cable, a pair shielded coaxial cable, and 4 fibre-optic cable, the outside have two broken lines which is covering with insulated plastic.

The new improved telephone jack (13) is installed by telephone company on the wall of the each house, each room and each office, to instead of the old telephone jack, and it's connecting cable (16) is connected to the in-terminal of the local telephone network this device is using as the client input terminal (access-point) of the local telephone network, it will be input and transmission with various signals at same time, such as audio signal, television signal, video signal, multimedia signal, the various analogue signals and digital signals.

Then, installed the new improved telephone jack (13) in the device of the telephone machine, or television, or computer, to instead of the old telephone jack, but the correspondence connecting cable of telephone plugs (12), which is inserted in this jack (13), is connecting with client input terminal of local telephone networking finally.

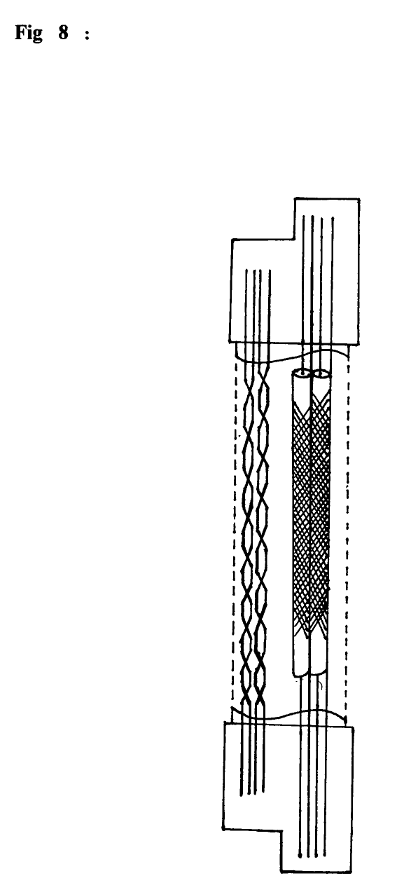

For example 3: Turning generally to FIG. 8: This is the plugs and the connecting cable, which consists of the twisted-pair cable (4 lines) and the pair shielded coaxial cable (4 lines). It's construction is the (plug-connecting cable-plug), the one terminal of the connecting cable is connected with one new telephone plug and another terminal is connected with another plug, it is using as a connecting cable with device and local telephone networking, one plug is connecting finally into the device, such as the telephone machine, or the television, or the computer, and another plug is connecting finally into the client input terminal of local telephone networking

1) The telephone plug and jack with transmission various signals which involves the telephone plug, the telephone jack, and the connecting cable, The specific property is that it's construction is (jack-connecting cable), the telephone jack is installing on the wall of the room or of the office, or any place, and the cable, which is connected with jack, is connecting with the local telephone networking this device is using as the client input terminal (access point) of the local telephone networking; it will be input and transmission with various signals at same time, such as audio signal, television signal, video signal, multimedia signal, the various analogue signals and digital signals.

2) The telephone plug and jack with transmission various signals which involves the telephone plug, the telephone jack, and the connecting cable, The specific property is that it's construction is (plug-connecting cable), the telephone plug is installing on the wall of the room or of the office, or any place, and the cable, which is connected with plug, is connecting with the local telephone networking, this device is using as the client input terminal (access point) of the local telephone networking it will be input and transmission with various signals at same time, such as audio signal, television signal, video signal, multimedia signal, the various analogue signals and digital signals.

3) This invention is a new product according to claim 1 wherein said, The specific property is that the telephone jack is installing in the device of the telephone machine, or the television, or the computer machine, but the connecting cable of plug, which is inserted in this jack, is connecting with the client input terminal of local telephone networking finally; it will be input and transmission with various signals at same time, such as audio signal, television signal, video signal, multimedia signal, the various analogue signals and digital signals.

4) This invention is a new product according to claim 2 wherein said, The specific property is that the telephone plug is installing in the device of the telephone machine, or the television, or the computer machine, but the connecting cable of jack, which is inserted in this plug, is connecting with the client input terminal of local telephone networking finally it will be input and transmission with various signals at same time, such as audio signal, television signal, video signal, multimedia signal, the various analogue signals and digital signals.

5) This invention is a new product according to claim 2 wherein said, The specific property is that it's construction is (plug-connecting cable-plug), one terminal of connecting cable is connected with one new telephone plug and another terminal is connected with another plug, it is using as a connecting cable with device and local telephone networking, one plug is connected finally into the device, such as the telephone machine, or the television, or the computer, and another plug is connected finally into the client input terminal of local telephone networking; it will be input and transmission with various signals at same time, such as audio signal television signal, video signal, multimedia signal, the various analogue signals and digital signals.

6) This invention is a new product according to claim 1 wherein said, The specific property is that it's construction is (jack-connecting cable-jack), one terminal of connecting cable is connected with one new telephone jack and another terminal is connected with another jack, it is using as a connecting cable with device and local telephone networking, one jack is connected finally into the device, such as the telephone machine, or the television, or the computer, and another jack is connected finally into the client input terminal of local telephone networking; it will be input and transmission with various signals at same time, such as audio signal television signal, video signal, multimedia signal, the various analogue signals and digital signals.

7) This invention is a new product according to claim 1 or 2 wherein said, The specific property is that it's construction is (plug-connecting cable-jack), one terminal of connecting cable is connected with one new telephone plug and another terminal is connected with new telephone jack, it is using as a connecting cable with device and local telephone networking, one terminal of the connecting cable is connected finally into the device, such as the telephone machine, or the television, or the computer, and another terminal is connected finally into the client input terminal of local telephone networking it will be input and transmission with various signals at same time, such as audio signal, television signal, video signal, multimedia signal, the various analogue signals and digital signals.

8) This invention is a new product according to claim 1 or 2 wherein said, which is a new kind of improved telephone jack/(or plug) with it's connecting cable, The specific property is that the shape of the new improved telephone jack/(or plug) is one kind of the circle shaped, [symbol] shaped, [symbol] shaped, [symbol] shaped, or the any shaped.

9) This invention is a new product according to claim 1 or 2 wherein said, which is a new kind of improved telephone jack/(or plug) with it's connecting cable, The specific property is that the line's number of the interface with the new improved telephone jack/(or plug) and it's interconnecting cable is 4 lines, 8 lines, 12 lines or until to N lines. (N=1, 2, 3, 4, 5, 6, - - - 99, - - - ).

10) This invention is a new product according to claim 1 or 2 wherein said, which is a new kind of improved telephone jack/(or plug) with it's connecting cable, The specific property is that the connecting cable, which is connected with the new improved telephone jack/(or plug), is a kind of the cable, such as the twisted-pair cable, or the shielded coaxial cable, or the fibre-optic cable, or any high-capacity cable.

11) This invention is a new product according to claim 1 or 2 wherein said, which is a new kind of improved telephone jack/(or plug) with it's connecting cable, The specific property is that the new connecting cable, which is connected with the new improved telephone jack/(or plug), is a kind of new mixed cable, it consists of the twisted-pair cable, the shielded coaxial cable the fibre-optic cable, and the any high-capacity cable, and it also consists of any two kinds, or any three kinds, or any four kinds, - - - .

12) This invention is a new product according to claim 5 wherein said, The specific property is that it's construction is (K plugs-connecting cable-M plugs), one terminal of connecting cable is connected with K new telephone plugs and another terminal is connected with M plugs; it is using as a connecting cable with device and local telephone networking, (K=1, 2, 3, 4, - - - ), (M=1, 2, 3, 4, - - - ).

13) This invention is a new product according to claim 6 wherein said, The specific property is that it's construction is (K jacks-connecting cable-M jacks), one terminal of connecting cable is connected with K new telephone jacks and another terminal is connected with M jacks; it is using as a connecting cable with device and local telephone networking, (K=1, 2, 3, 4, - - - ), (M=1, 2, 3, 4, - - - ).

14) This invention is a new product according to claim 5 and 6 wherein said, The specific property is that it's construction is (K plugs-connecting cable-M jacks), one terminal of connecting cable is connected with K new telephone plugs and another terminal is connected with M new telephone jacks; it is using as a connecting cable with device and local telephone networking, (K=1, 2, 3, 4, - - - ), (M=1, 2, 3, 4, - - - ).

15) This invention is a new product according to claim 1 or 2 wherein said, which is a new kind of improved telephone jack/(or plug) with it's connecting cable, The specific property is that the connecting cable, which is connected with the new improved telephone jack/(or plug), is the shielded coaxial cable, this device is using as the client input terminal (access point) of the local telephone networking; it will be input and transmission with various signals at same time, such as audio signal, television signal video signal, multimedia signal, the various analogue signals and digital signals

16) This invention is a new product according to claim 1 or 2 wherein said, which is a new kind of improved telephone jack/(or plug) with it's connecting cable, The specific property is that the connecting cable, which is connected with the new improved telephone jack/(or plug), is the fibre-optic cable this device is using as the client input terminal (access point) of the local telephone networking; it will be input and transmission with various signals at same time, such as audio signal, television signal, video signal, multimedia signal, the various analogue signals and digital signals.

17) This invention is a new product according to claim 1 or 2 wherein said, which is a new kind of improved telephone jack/(or plug) with it's connecting cable, The specific property is that the connecting cable, which is connected with the new improved telephone jack/(or plug), is a kind of any high capacity cable, this device is using as the client input terminal (access point) of the local telephone networking it will be input and transmission with various signals at same time, such as audio signal, television signal, video signal, multimedia signal, the various analogue signals and digital signals.
